(19) United States
(12) Patent Application Publication
(10) Pub. No.: US 2008/0118828 A1
(43) Pub. Date: May 22, 2008

(54) Dual voltage battery with separate terminals

(76) Inventor: Dudlee Brennfoerder, Edgar, NE (US)

Correspondence Address: Law Offices of Adam H. Jacobs;Suite 726, 1904 Farnam Street, Omaha, NE, 68102, US

(21) Appl. No.: 11/986,343

(22) Filed: Nov. 21, 2007

Related U.S. Application Data
(60) Provisional application No. 60/860,833, filed on Nov. 22, 2006.

(51) Int. Cl. H01M 2/24

(52) U.S. Cl. 429/160

(57) ABSTRACT

The present invention provides a dual voltage battery with separate terminals which includes an outer case and a plurality of current-producing battery cells mounted within the outer case, the plurality of battery cells being connected in serial connection. A negative ground terminal is mounted on the outer case, and a first positive terminal is mounted on the outer case and is connected to at least some of the battery cells via the serial connection to produce 12 volt current output therefrom. A second positive terminal is mounted on the outer case and is connected to all of the battery cells via the serial connection to produce 16 volt current output therefrom. Finally, the first and second positive terminals are separate from one another such that the dual voltage battery outputs 12 volt and 16 volt current simultaneously via the first and second positive terminals.

### CROSS-REFERENCE TO RELATED PATENTS

This application claims priority based on a provisional patent, specifically on the Provisional Patent Application Ser. No. 60/860,833 filed Nov. 22, 2007.

### BACKGROUND OF THE INVENTION

1. Technical Field

The present invention is directed to vehicle batteries and, more particularly, to a dual voltage output vehicle battery which includes eight battery cells connected in serial connection, a negative terminal, a first positive terminal connected to six of the battery cells in series to produce 12 volt output, a second positive terminal connected to all eight of the battery cells in series to produce 16 volt output, the first and second positive terminals being separate from one another such that the dual voltage output vehicle battery is connectable to two separate electrical systems in the same vehicle, thus powering high performance vehicle electrical accessories as well as standard vehicle electrical accessories.

2. Description of the Prior Art

It should be noted that many high-performance racing ignition systems and performance and competitive audio systems require at least 12 volts to produce optimal spark. As was discussed previously, a typical lead-acid battery cell produces a maximum of 2.1 volts per cell or 12.6 volts total. Under load, the voltage can rapidly drop to 2.0 per cell or 12 volts total or even below that level with a continuing load. Operating below this voltage level can cause ignition problems such as a high-speed miss, or problems with audio equipment including amp failure and component malfunction. Reduced voltage will also negatively affect the starter's ability to spin the motor. The primary reason for using a 16-volt battery is, of course, to improve the performance, reliability and consistency of the ignition and audio systems. However, many other electrical accessories on the vehicle cannot function with delivery of 16 volts, instead requiring a 12 volt feed to prevent damage to the accessory, ignition head units, etc. There is therefore a need for a vehicle battery which can simultaneously supply a 16 volt and a 12 volt output, yet which does not require significant modification of existing equipment for use thereof.

There are examples of batteries in the prior art which attempt to address and solve this issue, but invariably these batteries include only one negative and one positive terminal and some type of switching device which controls the voltage output to the terminals. While this design may be adequate for certain uses, in situations where simultaneous output of both 12 volt and 16 volt current is demanded, these devices fall short of solving the existing problems. There is therefore a need for a vehicle battery which can simultaneously supply a 16 volt and a 12 volt output from separate battery terminals to allow for the simultaneous supply of current therefrom.

Therefore, an object of the present invention is to provide an improved dual voltage battery with separate terminals.

Another object of the present invention is to provide an improved dual voltage battery with separate terminals which does not require the user to switch between 12 volt and 16 volt output as both outputs are available simultaneously.

Another object of the present invention is to provide an improved dual voltage battery with separate terminals which fits within a standard vehicle battery mount so that a user of the present invention does not have to make significant modifications to the internal vehicle structure to use the battery of the present invention.

Another object of the present invention is to provide an improved dual voltage battery with separate terminals which includes eight (8) individual battery cells linked in serial configuration with one terminal (the 12 volt terminal) connected to six (6) of the cells and a second terminal (the 16 volt terminal) connected to all of the cells.

Finally, an object of the present invention is to provide improved dual voltage battery with separate terminals which is relatively simple and durable in construction and is safe, efficient and effective in use.

### SUMMARY OF THE INVENTION

The present invention provides a dual voltage battery with separate terminals which includes an outer case and a plurality of current-producing battery cells mounted within the outer case, the plurality of battery cells being connected in serial connection. A negative ground terminal is mounted on the outer case, and a first positive terminal is mounted on the outer case and extends therethrough, the first positive terminal connected to at least some of the battery cells via the serial connection to produce 12 volt current output therefrom. A second positive terminal is mounted on the outer case and extends therethrough, the second positive terminal connected to all of the battery cells via the serial connection to produce 16 volt current output therefrom. Finally, the first and second positive terminals are separate from one another such that the dual voltage battery outputs 12 volt and 16 volt current simultaneously via the first and second positive terminals.

The present invention thus provides numerous advantages over the prior art. For example, because the present invention includes three separate battery terminals, two of which are positive for different voltages, separate electrical systems may be connected to the battery and can remain connected regardless of which system is drawing power from the battery, thus eliminating the need for disconnecting and reconnecting the separate electrical system devices. Furthermore, as the present invention eliminates the need for a switching device which is usable to switch between 12 volt and 16 volt output, because the battery outputs both voltages simultaneously, the present invention can be used with electrical systems requiring different voltages yet which the user desires to use simultaneously. Finally, because the present invention utilizes existing technology in a new functional configuration, it may be quickly and easily constructed and implemented, which renders the present invention a substantial improvement over the prior art.

### BRIEF DESCRIPTION OF THE DRAWINGS

FIG. 1 is a perspective view of the dual voltage output vehicle battery of the present invention; and

FIG. 2 is a detailed perspective view of the dual voltage output vehicle battery of the present invention showing the internal elements thereof.

### DESCRIPTION OF THE PREFERRED EMBODIMENT

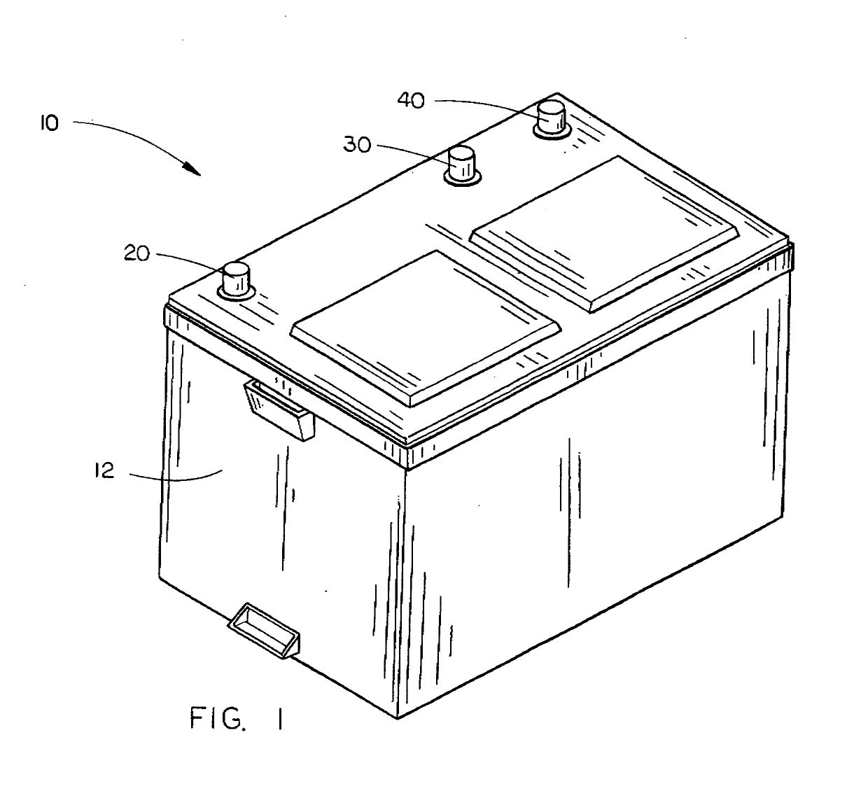

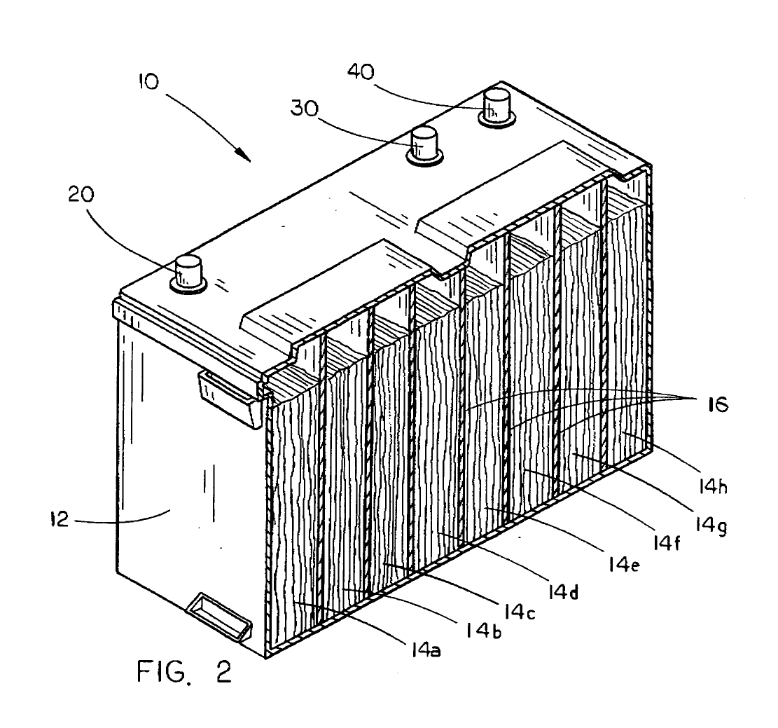

The dual voltage output vehicle battery 10 of the present invention is shown best in FIGS. 1 and 2 as including a battery case 12 which is preferably constructed of a reinforced, gusseted, high impact polyethylene case material to ensure that the battery 10 is highly resistant to impact and vibration damage and further that the case material reinforces the unit's rigidity. Mounted on the outer top wall of the battery case 12 are three battery terminals, the first being a standard ground or negative terminal 20, the second terminal (shown in yellow in FIG. 1) being the 12-volt positive terminal 30 and the third terminal (shown in red in FIG. 1) being the 16-volt positive terminal 40. The terminals 20, 30 and 40 may be of any appropriate design, and it has been found that the terminal design is not critical to the functionality of the present invention regarding voltage and amperage output, so long as the terminals are conductive and relatively easy and secure to mount the electrical system connection wires thereto. The connection of the negative terminal 20 within the dual voltage output vehicle battery 10 of the present invention would be generally similar to the standard negative terminal battery connection commonly used in connection with standard vehicle batteries, and in fact, the specific nature of the electrical connections of all of the terminals 20, 30 and 40 within the battery would be generally similar to those electrical connections found currently in the prior art with the only significant modifications being that the connections are designed for use in high-performance and audio situations where impacts and vibrations, high voltage and amperage draws are far more likely. The electrical connections are therefore made as impact-resistant and vibration-resistant as is reasonably practicable, and such modifications are known to those skilled in the art of the manufacture of high-performance and audio batteries.

The internal elements of the dual voltage output vehicle battery 10 of the present invention are best shown in FIG. 2 which is a detailed cutaway view of those elements. Mounted within the battery case 12 are eight battery cells 14a, 14b, 14c, 14d, 14e, 14f, 14g and 14h which are positioned in generally upright parallel configuration. The eight battery cells are connected to one another in serial configuration such that the voltage and amperage output from the battery cells is the compilation of outputs of all of the battery cells 14a-h, thus providing the power output for the dual voltage output vehicle battery 10. In the preferred embodiment, each of the battery cells 14a-h would be constructed in a similar manner as a standard lead cell battery cell of the kind presently known and used for vehicle batteries, namely that each battery cell 14a-h would be a set of lead plates with the separators 16 being an absorbent glass mat (ABM) material, which also suspends the electrolyte in the battery, which makes it generally impervious to vibration, heat and plate deterioration. Of course, other types of cells may be used with the present invention, but it has been found that the standard type of lead acid battery cell arrangement performs well within the dual voltage output vehicle battery 10 of the present invention.

Each of the battery cells 14a-h would preferably produce approximately 2.1 volts, and therefore with all eight cells 14a-h connected in serial connection, the total voltage output by the battery cells 14a-h is approximately 16.8-17.2 volts, depending on the temperature and operating conditions in which the battery cells 14a-h are operating. The critical functional feature of the present invention relates directly to the battery cells 14a-h, however, and that is that the 12-volt positive terminal 30 is connected to the first six battery cells 14a-f in serial connection and the 16-volt positive terminal 40 is connected to all eight battery cells 14a-h in serial connection. This means that the voltage output from the 12-volt positive terminal 30 is approximately 12.6-13.2 volts at peak performance, but is normally and nominally approximately 12 volts, as per a standard vehicle battery. However, the voltage output from the 16-volt positive terminal 40, which is connected to all of the battery cells 14a-h, will be approximately 16.8 volts at peak performance, but is normally and nominally approximately 16 volts.

Each of the 12-volt positive terminal 30 and 16-volt positive terminal 40 can operate independently of one another, which is a significant advantage over those variable voltage output batteries found in the prior art, as this permits the dual voltage output vehicle battery 10 of the present invention to be connected to separate electrical systems in the vehicle, such as where certain accessories must be connected to a 12-volt power supply or they may be damaged. Also, many previously used 16 volt batteries were effectively 12 volt batteries with a four volt battery connected thereto whereas the dual voltage output vehicle battery 10 of the present invention is a full 16 volt battery with each of the battery cells 14a-h serially connected as a single unit. This is important for several reasons, including that the discharge is equalized more evenly over the whole battery making them more efficient, the charge rate is also evenly distributed, reducing the possibility of having cells ruined by unequal charging, problems known to exist with a “cross-over strap or link” are eliminated, such as melting or separating and, perhaps most importantly, all of the performance characteristics are enhanced, including a significant increase in vibration protection damage by having one complete battery instead of two individual and combined systems.

In addition, there are numerous other advantages of the present invention including the following:
1) The battery is constructed with an internal absorbent glass mat material—previous models were leaky lead acid.
2) The battery case 12 is extremely durable.
3) The cold crank amp (CCA) output is increased.
4) The terminals 20, 30 and 40 are constructed of stainless steel, and thus are corrosion-proof.
5) The battery 10 is designed to fit the Standard Group 24 BCI battery case, thus simplifying use in most vehicles.
6) The battery 10 is heat and vibration resistant.
7) Finally, the battery 10 is spill-proof, and therefore will not leak or outgas unless the case 12 is intentionally abused.

It should be noted that the battery 10 of the present invention is primarily designed to supply the ignition system, starter system, fuel and water pump systems, and audio systems with the 16 volt power feed by connection to the 16-volt positive terminal 40, whereas the 12-volt positive terminal 30 can be connected to the remaining electrical accessories or components of the vehicle which cannot run on 16 volts. This simultaneous connection is critical in realizing the usage potential of the present invention, as it is not practical to require shifting of voltage output should different systems require different voltage outputs or “step down” boxes or regulators and it is likewise impractical to supply two batteries of differing outputs for different electrical systems in the vehicle. It is believed that the dual voltage output vehicle battery 10 thus provides a significant improvement over those batteries found in the prior art.

Also, as was discussed previously, the use of eight battery cells 14a-h within the battery, rather than the 6 cells used in 12 Volt batteries, equates to higher voltage. The cells used in the present invention make use of a hybrid plate technology that offers the benefits of both deep cycle and starting batteries. This technology results in a battery that is highly capable of not only extreme cranking capacity but also the ability to endure deep discharges. Furthermore, the design allows the battery to retain over 14.4 volts under extreme load without the use of an alternator in events such as a drag race or audio competition. The use of 16 to 18 volt performance alternators further enhances the capabilities of the 16 volt batteries by providing in excess of 19 volts, but not to exceed 19.2 volts, which is more than adequate not only for charging the battery 10 of the present invention but also providing unequivocal power during extreme competition.

It is to be understood that numerous additions, modifications and substitutions may be made to the dual voltage output vehicle battery 10 of the present invention which fall within the intended broad scope of the above description. For example, the size, shape and construction materials used in connection with the battery 10, battery case 12, battery cells 14a-h and battery terminals 20, 30 and 40 may be modified or changed so long as the intended functional features are neither significantly degraded nor destroyed. Furthermore, although the present invention has been described as being generally designed for use in connection with vehicles, it should be noted that the battery 10 may be used in any appropriate situation requiring dual voltage outputs obtainable only through use of the present invention, such as in connection with racing applications, high-power and high-performance audio equipment, high-performance vehicle accessories and stock accessories as per the needs of the user of the present invention. Finally, it should be noted that the battery cells 14a-h may be upgraded or modified as technology improves, and such improvements and modifications would be understood by one skilled in the art of battery manufacture.

There has therefore been shown and described a dual voltage output vehicle battery 10 which accomplishes all of its intended objectives.

I claim:

1. A dual voltage battery with separate terminals comprises:
an outer case;
a plurality of current-producing battery cells mounted within said outer case, said plurality of battery cells connected in serial connection;
a negative ground terminal mounted on said outer case;
a first positive terminal mounted on said outer case and extending therethrough, said first positive terminal connected to at least some of said plurality of battery cells via said serial connection to produce a first voltage current output therefrom;
a second positive terminal mounted on said outer case and extending therethrough, said second positive terminal connected to all said plurality of battery cells via said serial connection to produce a second voltage current output therefrom having a voltage value different from said first voltage current output; and
said first and second positive terminals being separate from one another such that said dual voltage battery outputs said first and second voltage current outputs simultaneously via said first and second positive terminals.

2. The dual voltage battery with separate terminals of claim 1 wherein said first voltage current output is approximately twelve (12) volts.

3. The dual voltage battery with separate terminals of claim 1 wherein said second voltage current output is approximately sixteen (16) volts.

4. The dual voltage battery with separate terminals of claim 1 wherein said plurality of battery cells comprises eight (8) battery cells each producing approximately 2.1 volts.

5. The dual voltage battery with separate terminals of claim 4 wherein said first positive terminal is connected to six (6) of said battery cells via said serial connection.

6. The dual voltage battery with separate terminals of claim 4 wherein said second positive terminal is connected to eight (8) of said battery cells via said serial connection.

7. The dual voltage battery with separate terminals of claim 1 wherein said first and second positive terminals are positioned in spaced apart relation on said outer case of said battery.

8. A dual voltage battery with separate terminals comprises:
an outer case;
a plurality of current-producing battery cells mounted within said outer case, said plurality of battery cells connected in serial connection;
a negative ground terminal mounted on said outer case;
a first positive terminal mounted on said outer case and extending therethrough, said first positive terminal connected to at least some of said plurality of battery cells via said serial connection to produce approximately 12 volts therefrom;
a second positive terminal mounted on said outer case and extending therethrough, said second positive terminal connected to all said plurality of battery cells via said serial connection to produce approximately 16 volts therefrom; and
said first and second positive terminals being separate from one another such that said dual voltage battery outputs said approximately 12 volts and said approximately 16 volts simultaneously via said first and second positive terminals.

9. The dual voltage battery with separate terminals of claim 8 wherein said plurality of battery cells comprises eight (8) battery cells each producing approximately 2.1 volts.

10. The dual voltage battery with separate terminals of claim 9 wherein said first positive terminal is connected to six (6) of said battery cells via said serial connection.

11. The dual voltage battery with separate terminals of claim 9 wherein said second positive terminal is connected to eight (8) of said battery cells via said serial connection.

12. The dual voltage battery with separate terminals of claim 8 wherein said first and second positive terminals are positioned in spaced apart relation on said outer case of said battery.
